(19) United States
(12) Patent Application Publication
(10) Pub. No.: US 2013/0098459 A1
(43) Pub. Date: Apr. 25, 2013

(54) Closed-Loop Hydraulic System Having Flow Combining and Recuperation

(71) Applicant: Patrick Opdenbosch, Peoria, IL (US)

(72) Inventor: Patrick Opdenbosch, Peoria, IL (US)

(21) Appl. No.: 13/278,623

(22) Filed: Oct. 21, 2011

(51) Int. Cl. F17D 3/00; F17D 1/20

(52) U.S. Cl. 137/2; 137/563

(57) ABSTRACT

A hydraulic system is disclosed. The hydraulic system may have a plurality of closed-loop circuits fluidly connecting a plurality of pumps to a plurality of actuators, and at least one control valve configured to selectively fluidly connect a first of the plurality of closed-loop circuits to a second of the plurality of closed loop circuits. The hydraulic system may also have an accumulator configured to receive pressured fluid from and discharge pressurized fluid to at least the first of the plurality of closed-loop circuits.

### TECHNICAL FIELD

The present disclosure relates generally to a hydraulic system and, more particularly, to a meterless hydraulic system having flow combining and recuperation.

### BACKGROUND

A conventional hydraulic system includes a pump that draws low-pressure fluid from a tank, pressurizes the fluid, and makes the pressurized fluid available to multiple different actuators for use in moving the actuators. In this arrangement, a speed of each actuator can be independently controlled by selectively throttling (i.e., restricting) a flow of the pressurized fluid from the pump into each actuator. For example, to move a particular actuator at a high speed, the flow of fluid from the pump into the actuator is restricted by only a small amount. In contrast, to move the same or another actuator at a low speed, the restriction placed on the flow of fluid is increased. Although adequate for many applications, the use of fluid restriction to control actuator speed can result in flow losses that reduce an overall efficiency of a hydraulic system.

An alternative type of hydraulic system is known as a closed-loop hydraulic system. A closed-loop hydraulic system generally includes a pump connected in closed-loop fashion to a single actuator or to a pair of actuators operating in tandem. During operation, the pump draws fluid from one chamber of the actuator(s) and discharges pressurized fluid to an opposing chamber of the same actuator(s). To move the actuator(s) at a higher speed, the pump discharges fluid at a faster rate. To move the actuator(s) with a lower speed, the pump discharges the fluid at a slower rate. A closed-loop hydraulic system is generally more efficient than a conventional hydraulic system because the speed of the actuator(s) is controlled through pump operation as opposed to fluid restriction. That is, the pump is controlled to only discharge as much fluid as is necessary to move the actuator(s) at a desired speed, and no throttling of a fluid flow is required.

An exemplary closed-loop hydraulic system is disclosed in a technical document titled “Hybrid Displacement Controlled Multi-Actuator Hydraulic System” by Zimmerman et al. that was presented in the Twelfth Scandinavian International Conference on Fluid Power, May 18-20, 2011, in Tampere, Finland. In this document, a multi-actuator meterless-type hydraulic system is described that has flow-combining and energy recuperation functionality. The hydraulic system includes a swing circuit, a boom circuit, a stick circuit, and a bucket circuit, each circuit having a dedicated pump connected to a specialized actuator in a closed-loop manner. The boom, stick, and bucket circuits are also connected to each other via makeup/relief valves that move based on pressure differentials, such that the fluid from a charge circuit may be combined with fluid from any other circuit. The boom, stick, and bucket circuits can recover energy from their respective circuits by transferring excess power to the swing circuit via a mechanical connection between the pumps of each circuit. In addition, an accumulator is associated with all of the circuits and configured to discharge fluid at select times to any of the circuits based on fluid pressure differentials, thereby improving efficiency of the engine and lowering an output requirement of the engine.

Although an improvement over existing meterless hydraulic systems, the meterless hydraulic system of the technical document described above may still be less than optimal. In particular, because the fluid combining, recovery, and reuse may be implemented based only on pressure differentials, control over these processes may be limited. In addition, because each of the actuators requires its own dedicated pump, the system may be large and expensive.

The hydraulic system of the present disclosure is directed toward solving one or more of the problems set forth above and/or other problems of the prior art.

### SUMMARY

In one aspect, the present disclosure is directed to a hydraulic system. The hydraulic system may include a plurality of closed-loop circuits fluidly connecting a plurality of pumps to a plurality of actuators, and at least one control valve configured to selectively fluidly connect a first of the plurality of closed-loop circuits to a second of the plurality of closed loop circuits. The hydraulic system may also include an accumulator configured to receive pressured fluid from and discharge pressurized fluid to at least the first of the plurality of closed-loop circuits.

In another aspect, the present disclosure is directed to a method of operating a hydraulic system. The method may include pressurizing fluid with a plurality of pumps, and directing fluid pressurized by the plurality of pumps to a plurality of actuators and returning fluid from the plurality of actuators to the plurality of pumps via a plurality of closed-loop circuits. The method may also include selectively directing fluid from at least a first of the plurality of closed-loop circuits to combine with fluid within a second of the plurality of closed-loop circuits, selectively accumulating within a common accumulator fluid from at least the first of the plurality of closed-loop circuits, and selectively discharging fluid from the common accumulator to at least the first of the plurality of closed-loop circuits.

### BRIEF DESCRIPTION OF THE DRAWINGS

FIG. 1 is a pictorial illustration of an exemplary disclosed machine; and

FIG. 2 is a schematic illustration of an exemplary disclosed hydraulic system that may be used in conjunction with the machine of FIG. 1.

### DETAILED DESCRIPTION

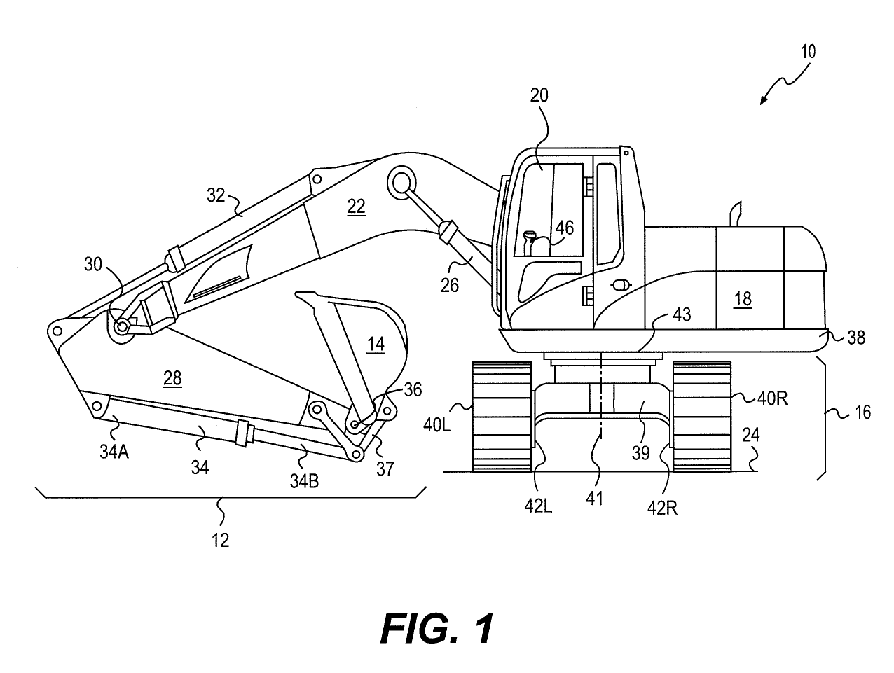

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dozer, a loader, a backhoe, a motor grader, a dump truck, or any other earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by fluid actuators to move work tool 14. Specifically, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 that is operatively connected between stick 28 and work tool 14 to pivot work tool 14 vertically about a horizontal pivot axis 36. In the disclosed embodiment, hydraulic cylinder 34 is connected at a head-end 34A to a portion of stick 28 and at an opposing rod-end 34B to work tool 14 by way of a power link 37. Boom 22 may be pivotally connected to a body 38 of machine 10. Body 38 may be pivotally connected to an undercarriage 39 and movable about a vertical axis 41 by a hydraulic swing motor 43. Stick 28 may pivotally connect boom 22 to work tool 14 by way of axis 30 and 36.

Numerous different work tools 14 may be attachable to a single machine 10 and operator controllable. Work tool 14 may include any device used to perform a particular task such as, for example, a bucket, a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction, work tool 14 may alternatively or additionally rotate, slide, open and close, or move in any other manner known in the art.

Drive system 16 may include one or more traction devices powered to propel machine 10. In the disclosed example, drive system 16 includes a left track 40L located on one side of machine 10, and a right track 40R located on an opposing side of machine 10. Left track 40L may be driven by a left-travel motor 42L, while right track 40R may be driven by a right-travel motor 42R. It is contemplated that drive system 16 could alternatively include traction devices other than tracks such as wheels, belts, or other known traction devices. Machine 10 may be steered by generating a speed and/or rotational direction difference between left and right-travel motors 42L, 42R, while straight travel may be facilitated by generating substantially equal output speeds and rotational directions from left and right-travel motors 42L, 42R.

Power source 18 may embody an engine such as, for example, a diesel engine, a gasoline engine, a gaseous fuel-powered engine, or any other type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving hydraulic cylinders 26, 32, 34 and left travel, right travel, and swing motors 42L, 42R, 43.

Operator station 20 may include devices that receive input from a machine operator indicative of desired machine maneuvering. Specifically, operator station 20 may include one or more operator interface devices 46, for example a joystick, a steering wheel, or a pedal, that are located proximate an operator seat (not shown). Operator interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

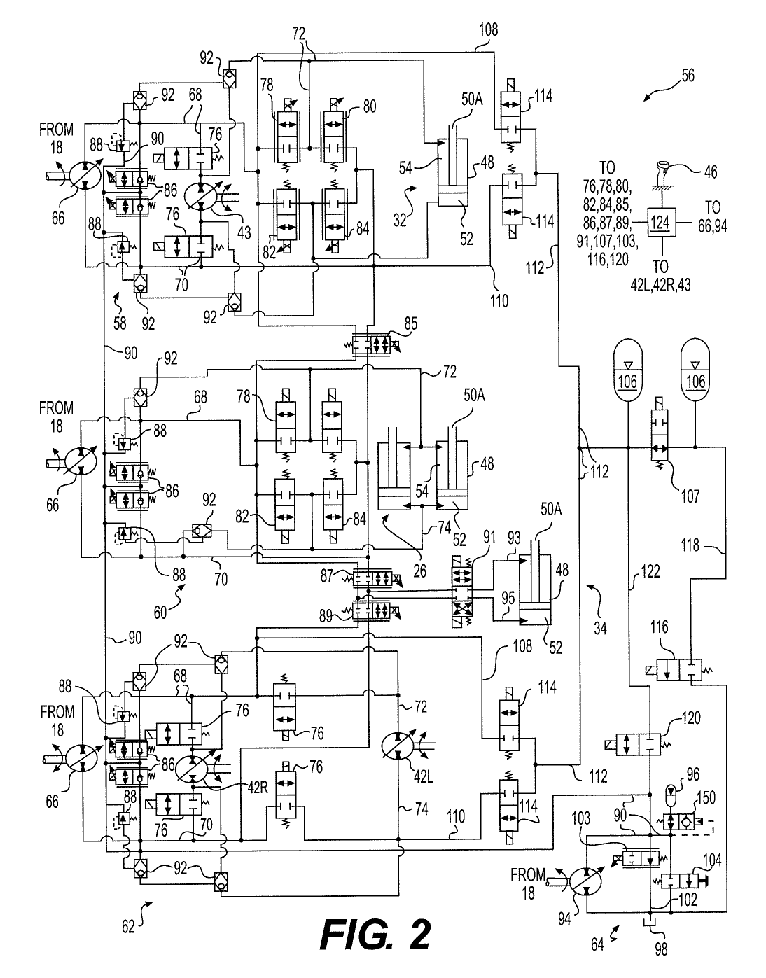

As shown in FIG. 2, hydraulic cylinders 26, 32, 34 may each include a tube 48 and a piston assembly 50 arranged within tube 48 to form a first chamber 52 and an opposing second chamber 54. In one example, a rod portion 50A of piston assembly 50 may extend through an end of second chamber 54. As such, second chamber 54 may be considered the rod-end chamber of hydraulic cylinders 26, 32, 34, while first chamber 52 may be considered the head-end chamber.

First and second chambers 52, 54 may each be selectively supplied with pressurized fluid and drained of the pressurized fluid to cause piston assembly 50 to displace within tube 48, thereby changing an effective length of hydraulic cylinders 26, 32, 34 and moving work tool 14 (referring to FIG. 1). A flow rate of fluid into and out of first and second chambers 52, 54 may relate to a translational velocity of hydraulic cylinders 26, 32, 34, while a pressure differential between first and second chambers 52, 54 may relate to a force imparted by hydraulic cylinders 26, 32, 34 on the associated linkage structure of implement system 12.

Swing motor 43, like hydraulic cylinders 26, 32, 34, may be driven by a fluid pressure differential. Specifically, swing motor 43 may include first and second chambers (not shown) located to either side of a pumping mechanism such as an impeller, plunger, or series of pistons (not shown). When the first chamber is filled with pressurized fluid and the second chamber is drained of fluid, the pumping mechanism may be urged to move or rotate in a first direction. Conversely, when the first chamber is drained of fluid and the second chamber is filled with pressurized fluid, the pumping mechanism may be urged to move or rotate in an opposite direction. The flow rate of fluid into and out of the first and second chambers may determine an output velocity of swing motor 43, while a pressure differential across the pumping mechanism may determine an output torque. In the disclosed embodiment, swing motor 43 is shown as being an over-center type motor having variable displacement, such that for a given flow rate and/or pressure of supplied fluid, a speed, torque, and/or rotational direction of swing motor 43 may be adjusted. It is contemplated, however, that the displacement of swing motor 43 may alternatively be fixed, if desired.

Similar to swing motor 43, each of left and right-travel motors 42L, 42R may be driven by creating a fluid pressure differential. Specifically, each of left and right-travel motors 42L, 42R may include first and second chambers (not shown) located to either side of a pumping mechanism (not shown). When the first chamber is filled with pressurized fluid and the second chamber is drained of fluid, the pumping mechanism may be urged to move or rotate a corresponding traction device (40L, 40R) in a first direction. Conversely, when the first chamber is drained of the fluid and the second chamber is filled with the pressurized fluid, the respective pumping mechanism may be urged to move or rotate the traction device in an opposite direction. The flow rate of fluid into and out of the first and second chambers may determine a velocity of left and right-travel motors 42L, 42R, while a pressure differential between left and right-travel motors 42L, 42R may determine a torque. In the disclosed embodiment, left and right travel motors 42L, 42R are shown as being over-center type motors having variable displacements, such that for a given flow rate and/or pressure of supplied fluid, a speed, torque, and/or rotational direction of these motors may be adjusted. It is contemplated, however, that the displacement of left and/or right travel motors 42L, 42R may alternatively be fixed, if desired.

As illustrated in FIG. 2, machine 10 may include a hydraulic system 56 having a plurality of fluid components that cooperate with the linear actuators (e.g., hydraulic cylinders 26, 32, 34) and the rotary actuators (e.g., left- and right-travel motors 42L, 42R, and swing motor 43) to move work tool 14 (referring to FIG. 1) and machine 10. In particular, hydraulic system 56 may include, among other things, a first circuit 58, a second circuit 60, a third circuit 62, and a charge circuit 64. First circuit 58 may be a stick circuit associated with hydraulic cylinder 32 and swing motor 43. Second circuit 60 may be a boom circuit associated with hydraulic cylinders 26 and, at select times, with hydraulic cylinder 34. Third circuit 62 may be a travel circuit associated with left- and right-travel motors 42L, 42R and, at select times, with hydraulic cylinder 34. Charge circuit 64 may be in selective fluid communication with each of first, second, and third circuits 58, 60, 62. It is contemplated that additional and/or different configurations of circuits may be included within hydraulic system 56 such as, for example, an independent circuit associated with each separate actuator (e.g., hydraulic cylinders 32, 34, 26, left-travel motor 42L, right-travel motor 42R, and/or swing motor 43), if desired.

In the disclosed embodiment, each of first, second, and third circuits 58, 60, 62 may be similar and include a plurality of interconnecting and cooperating fluid components that facilitate the use and control of the associated actuators. For example, each circuit 58, 60, 62 may include a pump 66 fluidly connected to its associated rotary and/or linear actuators in parallel via a closed-loop formed by upper-side and lower-side (relative to FIG. 2) passages. Specifically, each of circuits 58, 60, 62 may include an upper pump passage 68, a lower pump passage 70, an upper actuator passage 72, and a lower actuator passage 74. Within first circuit 58, pump 66 may be connected to swing motor 43 via upper and lower pump passages 68, 70, and to hydraulic cylinder 32 via upper and lower pump and actuator passages 70-74. Within second circuit 60, pump 66 may be connected to hydraulic cylinders 26 via upper and lower pump and actuator passages 70-74. Within third circuit 62, pump 66 may be connected to right-travel motor 42R via upper and lower pump passages 68, 70, and to left travel motor 42L via upper and lower pump and actuator passages 70-74.

To cause right-travel motor 42R and/or swing motor 43 to rotate in a first direction, upper pump passages 68 of the respective circuits may be filled with fluid pressurized by the associated pump(s) 66, while lower pump passage 70 may be filled with fluid exiting the motor(s). To reverse direction of right-travel motor 42R and/or swing motor 43, lower actuator passage 70 of the respective circuits may be filled with fluid pressurized by the associated pump(s) 66, while upper pump passage 68 may be filled with fluid exiting the motor(s). During an extending operation of hydraulic cylinders 32 and/or 36 and during rotation of left travel motor 42L in a first direction, lower actuator passage 74 may be filled with fluid pressurized by the associated pump(s) 66, while upper actuator passage 72 may be filled with fluid returned from these actuators. In contrast, during a retracting operation of hydraulic cylinders 26 and/or 36 and during rotation of left travel motor 42L in a second direction, upper actuator passage 72 may be filled with fluid pressurized by the associated pump(s) 66, while lower actuator passage 74 may be filled with fluid returned from the cylinder(s).

Each pump 66 may have variable displacement and be controlled to draw fluid from its associated actuators and discharge the fluid at a specified elevated pressure back to the actuators in two different directions. That is, pump 66 may include a stroke-adjusting mechanism, for example a swashplate, a position of which is hydro- or electro-mechanically adjusted based on, among other things, a desired speed of the actuators to thereby vary an output (e.g., a discharge rate) of pump 66. The displacement of pump 66 may be adjusted from a zero displacement position at which substantially no fluid is discharged from pump 66, to a maximum displacement position in a first direction at which fluid is discharged from pump 66 at a maximum rate into upper pump passage 68. Likewise, the displacement of pump 66 may be adjusted from the zero displacement position to a maximum displacement position in a second direction at which fluid is discharged from pump 66 at a maximum rate into lower pump passage 70. Pump 66 may be drivably connected to power source 18 of machine 10 by, for example, a countershaft, a belt, or in another suitable manner. Alternatively, pump 66 may be indirectly connected to power source 18 via a torque converter, a gear box, an electrical circuit, or in any other manner known in the art. It is contemplated that pumps 66 of different circuits may be connected to power source 18 in tandem (e.g., via the same shaft) or in parallel (via a gear train), as desired.

Pump 66 may also be selectively operated as a motor. More specifically, when an associated actuator is operating in an overrunning condition, the fluid discharged from the actuator may have a pressure elevated higher than an output pressure of pump 66. In this situation, the elevated pressure of the actuator fluid directed back through pump 66 may function to drive pump 66 to rotate with or without assistance from power source 18. Under some circumstances, pump 66 may even be capable of imparting energy to power source 18, thereby improving an efficiency and/or capacity of power source 18.

During some operations, it may be desirable to cause movement of one actuator (e.g., a linear actuator as in first circuit 58 or a rotary actuator as in third circuit 62) within a particular circuit without significantly affecting movement of another actuator (e.g., a rotary actuator) within the same circuit. For this purpose, each of first and third circuits 58, 62 may be provided with isolation valves 76 capable of substantially isolating particular actuators from its associated pump 66 and/or other actuator(s) of the same circuit. Isolation valves 76, in the disclosed embodiment, may be on/off type valves that are solenoid-actuated toward a flow-passing position and spring-biased toward a flow-blocking position. When isolation valves 76 are in the flow-passing position, fluid may flow substantially unrestricted between upper and lower pump passages 68, 70 by way of the associated actuator. When isolation valves 76 are in the flow-blocking position, fluid flows within upper and lower pump passages 68, 70 may not pass through and substantially affect the motion of the actuator. In addition to isolating the associated actuator from operation of pump 66 and movement of another actuator, isolation valves 76 may also function as load-holding valves, hydraulically locking movement of the associated actuator, when the associated actuator has a non-zero displacement (in the case of a rotary actuator) and isolation valves 76 are in their flow-blocking positions.

In some situations, it may be beneficial for isolation valves 76 to throttle flow passing through their associated actuator. For example, in some instances when displacement of the associated pump 66 is limited and a corresponding pressure differential between upper and lower pump passages 68, 70 is also limited, it might be necessary to artificially increase a pressure differential across the actuator through selective throttling of the fluid flow in order to maintain desired performance of the actuator. Accordingly, it may be possible, in these situations, for isolation valves 76 to be moved to a position between the fully open flow-passing position and the fully closed flow-blocking position.

The linear actuator(s) of each circuit 58, 60, 62 may likewise be provided with valves used for isolation and/or load-holding purposes. In particular, each of first and second circuits 58, 60 may be provided with four valves, including a first rod-end valve 78, a second rod-end valve 80, a first head-end valve 82, and a second head-end valve 84. First rod-end valve 78 may be positioned between upper pump passage 68 and upper actuator passage 72. Second rod-end valve 80 may be positioned between lower pump passage 70 and upper actuator passage 72. First head-end valve 82 may be positioned between upper pump passage 68 and lower actuator passage 74. Second head-end valve 84 may be positioned between lower pump passage 70 and lower actuator passage 74. Like isolation valves 76, valves 78-84 may be on/off type valves that are solenoid-actuated toward a flow-passing position and spring-biased toward a flow-blocking position. To isolate a linear actuator from its associated pump 66 (and in first circuit 58 from its associated rotary actuator) and to hydraulically lock movement of the linear actuator, all of valves 78-84 may be moved to their flow-blocking positions.

Valves 78-84, in addition to facilitating isolation and load-holding of the associated linear actuator, may also provide flow-switching functionality. In particular, there may be times when movement of the associated rotary actuator in the first direction and retraction of the linear actuator is desired, while at other times movement of the associated rotary actuator in the first direction and extension of the linear actuator is desired. During the first situation, pump 66 may be required to pressurize upper pump passage 68 and upper actuator passage 72, while during the second situation, pump 66 may be required to pressurize upper pump passage 68 and lower actuator passage 74. Valves 78-84 may facilitate these operations. For example, when upper pump passage 68 is pressurized by pump 66 and retraction of the linear actuator is desired, first rod-end valve 78 may be moved to its flow-passing position such that upper actuator passage 72 and second chamber 54 of the linear actuator are also pressurized. At this same time, second head-end valve 84 may be in its flow-passing position such that fluid discharged from first chamber 52 passes through lower actuator passage 74 to lower pump passage 70 and back to pump 66. In contrast, when upper pump passage 68 is pressurized by pump 66 and extension of the linear actuator is desired, first head-end valve 82 may be moved to its flow-passing position such that lower actuator passage 74 and first chamber 52 of the linear actuator are also pressurized. At this same time, second rod-end valve 80 may be in its flow-passing position such that fluid discharged from second chamber 54 passes through upper actuator passage 72 to lower pump passage 70 and back to pump 66. Similar movements of valves 78-84 may be initiated to provide for movement of the rotary actuator in the second direction during extensions and retractions of the linear actuator.

In some embodiments, valves 78, 80, 82, and 84 may be used to facilitate fluid regeneration within the associated linear actuator. For example, when valves 80, 84 are moved to their flow passing positions and valves 78, 82 are in their flow-blocking positions, high-pressure fluid may be transferred from one chamber to the other of the linear actuator via valves 80, 84, without the fluid ever passing through pump 66. Similar functionality may alternatively be achieved by moving valves 78, 82 to their flow-passing positions while holding valves 80, 84 in their flow-blocking positions.

First, second, and third circuits 58-62 may be fluidly interconnected to share combined flows of fluid from the different pumps 66. For example, first circuit 58 may be selectively connected to second circuit 60 by way of a first combining valve 85. Similarly, second and third circuits 60, 62 may be selectively connected to each other and/or to hydraulic cylinder 32 via second and third combining valves 87, 89.

First combining valve 85 may be movable to any position between a first position at which upper pump passages 68 of first and second circuits 58, 60 are connected to each other and lower pump passages 70 are connected to each other, and a second position at which fluid communication between first and second circuits 58, 60 is inhibited. First combining valve 85 may be spring-biased toward the second position and solenoid-operated to move to any position between the second and first positions. When first combining valve 85 is in the first position, fluid from first circuit 58 may be allowed to combine with fluid in second circuit 60, thereby increasing a flow rate of fluid directed to hydraulic cylinders 26. Alternatively, when first combining valve 85 is in the first position, fluid from second circuit 60 may be allowed to combine with fluid in first circuit 58, thereby increasing a flow rate of fluid directed to swing motor 43 and/or to hydraulic cylinder 32. The increased flow rates of fluid may result in higher speed actuation of the respective cylinders and/or motor. The direction of fluid flow through first combining valve 85 (i.e., from first circuit 58 to second circuit 60 or vice versa) may be determined, at least in part, by a pressure differential between the two circuits. It is contemplated that first combining valve 85 may be a different type of valve, if desired. For example, first combining valve could include two separate valve elements (one associated with each of upper and lower pump passages 68, 70), four separate elements, or have another configuration known in the art).

Second and third combining valves 87, 89 may be utilized together to selectively connect upper pump passages 68 of second and third circuits 60, 62 with each other and lower pump passages 70 with each other. In addition, second and third combining valves 87, 89 may be used alone or together to fluidly connect hydraulic cylinder 34 with second and/or third circuits 60, 62 in closed-loop manner. For example, when second combining valve 87 is moved to the flow-passing position while second combining valve 89 is held in the flow-blocking position, hydraulic cylinder 34 may be driven by fluid from second circuit 60. Similarly, when third combining valve 89 is moved to the flow-passing position while second combining valve 87 is held in the flow-blocking position, hydraulic cylinder 34 may be driven by fluid from third circuit 62. Alternatively, both second and third combining valves 87, 89 may be simultaneously moved to their flow-passing positions, such that hydraulic cylinder 34 may be driven by fluid from both of second and third circuits 60, 62, thereby increasing a flow rate of fluid into and speed of hydraulic cylinder 34. It should be noted that although second and third combining valves 87, 89 are shown in FIG. 2 as being substantially identical to first combining valve 85, second and/or third combining valves 87, 89 may have an alternative configuration, if desired.

Hydraulic cylinder 34 may be provided with a switching valve 91 configured to control a movement direction of hydraulic cylinder 34, regardless of a flow direction of fluid through second and third combining valves 87, 89. In the depicted embodiment, switching valve 91 is shown as spool type valve located within rod- and head-end passages 93, 95 of hydraulic cylinder 34 and being movable between three discrete positions. When switching valve 91 is in a first position (upper position shown in FIG. 2), a given supply of fluid may flow from one or both of combining valves 87, 89 through hydraulic cylinder 34 in a first direction causing a corresponding movement of hydraulic cylinder 34 in a first direction (e.g., in an extending direction). When switching valve 91 is in a second position (middle position shown in FIG. 2), fluid flow through switching valve 91 may be inhibited, thereby also inhibiting movement of hydraulic cylinder 34. When switching valve 91 is in a third position (lower position shown in FIG. 2), the given supply of fluid may flow from one or both of combining valves 87, 89 through hydraulic cylinder 34 in a second direction causing a corresponding movement of hydraulic cylinder 34 in a second direction (e.g., in a retracting direction). Switching valve 91 may be spring-biased toward the second position and solenoid-movable to the first and second positions. It is contemplated that switching valve 91 could alternatively embody one or more poppet type valves, if desired, for example a group of four independent valves similar to valves 78-84. Likewise, valves 78-84 could be replaced with one or more spool type valves similar to switching valve 91, if desired.

It will be appreciated by those of skill in the art that the respective rates of hydraulic fluid flow into and out of first and second chambers 52, 54 of hydraulic cylinders 26, 32, 34 during extension and retraction may not be equal. That is, because of the location of rod portion 50A within second chamber 54, piston assembly 50 may have a reduced pressure area within second chamber 54, as compared with a pressure area within first chamber 52. Accordingly, during retraction of hydraulic cylinders 26, 32, 34, more hydraulic fluid may be forced out of first chamber 52 than can be consumed by second chamber 54 and, during extension, more hydraulic fluid may be consumed by first chamber 52 than is forced out of second chamber 54. In order to accommodate the excess fluid discharge during retraction and the additional fluid required during extension, each of circuits 58, 60, 62 may be provided with two makeup valves 86 and two relief valves 88 that connect upper and lower pump passages 68, 70 to charge circuit 64 via a common passage 90.

Makeup valves 86 may each be a variable position valve that is disposed between common passage 90 and one of upper and lower pump passages 68, 70 and configured to selectively allow pressurized fluid from charge circuit 64 to enter upper and lower pump passages 68, 70. In particular, each of makeup valves 86 may be solenoid-actuated from a first position at which fluid freely flows between common passage 90 and the respective upper and lower pump passages 68, 70, toward a second position at which fluid from common passage 90 may flow only into upper and lower pump passages 68, 70 when a pressure of common passage 90 exceeds the pressure of upper and lower pump passages 68, 70 by a threshold amount. Makeup valves 86 may be spring-biased toward their second positions, and only moved toward their first positions during operations known to have need of positive or negative makeup fluid. Makeup valves 86 may also be used to facilitate fluid regeneration between upper and lower pump passages 68, 70 within a particular circuit, by simultaneously moving together at least partway to their first positions. Makeup valves 86 may be used to facilitate regeneration alone, or in combination with valves 78-84 to enhance control during regeneration.

Relief valves 88 may be provided to allow fluid relief from each circuit 58, 60, 62 into charge circuit 64 when a pressure of the fluid exceeds a set threshold of relief valves 88. Relief valves 88 may be set to operate at relatively high pressure levels in order to prevent damage to hydraulic system 56, for example at levels that may only be reached when hydraulic cylinders 26, 32, 34 reach an end-of-stroke position and the flow from the associated pumps 66 is nonzero, or during a failure condition of hydraulic system 56. Each pair of relief valves 88 may connect to upper and lower pump and actuator passages 68-74 via different resolvers 92, such that a higher-pressure fluid of upper pump and actuator passages 68, 72 may be relieved to common passage 90 via one set of resolvers 92, and a higher-pressure fluid of lower pump and actuator passages 70, 74 may be relieved to common passage 90 via a remaining set of resolvers 92.

Charge circuit 64 may include at least one hydraulic source fluidly connected to common passage 90 described above. In the disclosed embodiment, charge circuit 64 has two sources, including a charge pump 94 and an accumulator 96, which may be fluidly connected to common passage 90 in parallel to provide makeup fluid to circuits 58, 60, 62. Charge pump 94 may embody, for example, an engine-driven, variable displacement pump configured to draw fluid from a tank 98, pressurize the fluid, and discharge the fluid into common passage 90. In one embodiment, charge pump 94 may be an over-center pump that allows for peak-shaving operations, as will be described in more detail below. Accumulator 96 may embody, for example, a compressed gas, membrane/spring, or bladder type of accumulator configured to accumulate pressurized fluid from and discharge pressurized fluid into common passage 90. Excess hydraulic fluid, either from charge pump 94 or from circuits 58, 60, 62 (i.e., from operation of pumps 66 and/or the rotary and linear actuators) may be directed into either accumulator 96 or into tank 98 by way of a return passage 102. In some embodiments, a variable position control valve 103 may be disposed within return passage 102 to help regulate a flow rate of fluid passing into tank 98. A manual service valve 104 may be associated with accumulator 96 to facilitate draining of accumulator 96 to tank 98 during service of charge circuit 64.

Hydraulic system 56 may be provided with means for recuperating fluid power. In particular, hydraulic system 56 may include at least one high-pressure accumulator 106. In the disclosed embodiment, two high-pressure accumulators 106 are utilized and separated by a two-position (e.g., flow-passing and flow-blocking), solenoid-actuated, combining valve 107. One or both of accumulators 106, depending on system demands, may be selectively connected to one or both of first and third circuits 58, 62 via combining valve 107 to either accumulate excess pressurized fluid or to discharge previously accumulated fluid. Accumulators 106 may be fluidly connected to upper or lower pump passages 68, 70 via accumulator passages 108 and 110, respectively, and via a common passage 112. Accumulator valves 114 may be disposed between common passage 112 and accumulator passages 108, 110 and configured to selectively control fluid flow between individual circuits 58, 62 and accumulators 106. Although accumulator valves 114 are shown as two-position (flow-blocking and flow-passing), solenoid actuated valves that are spring-biased toward flow-blocking positions, it should be noted that accumulator valves 114 may have another configuration, if desired. A manual service valve 116 may be associated with accumulators 106 to facilitate draining of accumulators 106 to tank 98 via a passage 118 during service.

In some embodiments, a valve 120 may be disposed within a passage 122 that connects accumulators 106 to common passage 90. Valve 120 may be a two-position (flow-blocking and flow-passing), solenoid-activated valve that is spring-biased toward the flow-blocking position. Valve 120 may be used to facilitate peak-shaving operations. That is, any time accumulators 106 have excess pressurized fluid (or any time pressurized fluid is directed to already full accumulators 106), the fluid may be directed through passage 122 and valve 120 into charge circuit 64. This fluid may then be utilized in several different ways, for example to fill low-pressure accumulator 96, to provide makeup fluid to circuits 58, 60, 62 if there is current demand, or to drive charge pump 94 in a direction that reduces a load on or adds capacity to power source 18. It is contemplated that valve 120 may also help protect accumulator 96 from damaging pressure spikes, in some applications. That is, valve 120 may be used to substantially isolate accumulator 96 from excessive pressures, and only open when the pressures of passage 122 are below a threshold pressure. Alternatively, an additional pilot-operated isolation valve 150 may be provided and directly associated with accumulator 96, if desired.

During operation of machine 10, the operator of machine 10 may utilize interface device 46 to provide a signal that identifies a desired movement of the various linear and/or rotary actuators to a controller 124. Based upon one or more signals, including the signal from interface device 46 and, for example, signals from various pressure sensors and/or position sensors located throughout hydraulic system 56, controller 124 may command movement of the different valves and/or displacement changes of the different pumps and motors to advance a particular one or more of the linear and/or rotary actuators to a desired position in a desired manner (i.e., at a desired speed and/or with a desired force).

Controller 124 may embody a single microprocessor or multiple microprocessors that include components for controlling operations of hydraulic system 56 based on input from an operator of machine 10 and based on sensed or other known operational parameters. Numerous commercially available microprocessors can be configured to perform the functions of controller 124. It should be appreciated that controller 124 could readily be embodied in a general machine microprocessor capable of controlling numerous machine functions. Controller 124 may include a memory, a secondary storage device, a processor, and any other components for running an application. Various other circuits may be associated with controller 124 such as power supply circuitry, signal conditioning circuitry, solenoid driver circuitry, and other types of circuitry.

### INDUSTRIAL APPLICABILITY

The disclosed hydraulic system may be applicable to any machine where improved hydraulic efficiency and performance is desired. The disclosed hydraulic system may provide for improved efficiency through the use of closed-loop technology. The disclosed hydraulic system may provide for enhanced performance through the selective use of a novel fluid combining and storage configuration. Operation of hydraulic system 56 will now be described.

During operation of machine 10, an operator located within station 20 may command a particular motion of work tool 14 in a desired direction and at a desired velocity by way of interface device 46. One or more corresponding signals generated by interface device 46 may be provided to controller 124 indicative of the desired motion, along with machine performance information, for example sensor data such a pressure data, position data, speed data, pump displacement data, and other data known in the art.

In response to the signals from interface device 46 and based on the machine performance information, controller 124 may generate control signals directed to pumps 66, 94 and/or to valves 76, 78, 80, 82, 84, 85, 86, 87, 89, 103, 107, 114, 116, 120. For example, to rotate swing motor 43 at an increasing speed in the first direction, controller 124 may generate a control signal that causes pump 66 of first circuit 58 to increase its displacement and discharge fluid into upper pump passage 68 at a greater rate. In addition, controller 124 may generate a control signal that causes isolation valves 76 to move toward and/or remain in their flow-passing positions. After fluid from pump 66 passes into and through swing motor 43 via upper pump passage 68, the fluid may return to pump 66 via lower pump passage 70. To reverse the motion of swing motor 43, the output direction of pump 66 may be reversed. If, during the motion of swing motor 43, the pressure of fluid within either of upper or lower pump passages 68, 70 becomes excessive (for example during an overrunning condition), fluid may be relieved from the pressurized passage to tank 98 via relief valves 88 and common passage 90. Alternatively or additionally, the pressurized fluid may be directed into accumulators 106 via accumulator passages 108 or 110, valves 114, and common passage 112. In contrast, when the pressure of fluid within either of upper or lower pump passages 68, 70 becomes too low, fluid from charge circuit 64 may be allowed into first circuit 58 via common passage 90 and makeup valves 86. Left and right-travel motors 42L, 42R may operate in a similar manner.

During the motion of swing motor 43, the operator may simultaneously request movement of hydraulic cylinder 32. For example, the operator may request via interface device 46 that hydraulic cylinder 32 be retracted at an increasing speed. When this occurs, controller 124 may generate a control signal that causes pump 66 of first circuit 58 to increase its displacement and discharge fluid into upper pump passage 68 at a greater rate. In addition, controller 124 may generate a control signal that causes first rod-end valve 78 and second head-end valve 84 to move toward and/or remain in their flow-passing positions. At this time, second rod-end valve 80 and first head-end valve 82 may be in their flow-blocking positions. As fluid from pump 66 passes into second chamber 54 of hydraulic cylinder 32 via upper pump and actuator passages 68, 72, fluid may be discharged from first chamber 52 back to pump 66 via lower pump and actuator passages 74, 70. Hydraulic cylinders 26 may operate in a similar manner.

The motion of hydraulic cylinder 32 may be reversed in two different ways. First, the operation of pump 66 may be reversed, thereby reversing the flows of fluid into and out of hydraulic cylinder 32. This same method may be utilized to reverse the direction of hydraulic cylinders 26. Although satisfactory in some situations, this method of reversing cylinder motion may only be possible when the motion of other actuators within the same circuit (e.g., swing motor 43) is also simultaneously reversed (e.g., when displacement is reversed so as to maintain travel in a desired constant direction) or when the other actuator(s) are already stopped and substantially isolated from pump 66 and the hydraulic cylinder. Otherwise, the motion of the hydraulic cylinder may be reversed by switching the positions of valves 78-84. If, during the motion of hydraulic cylinder 32 and/or hydraulic cylinder 26, the pressure of fluid within either of upper or lower pump passages 68, 70 becomes excessive (for example during an overrunning condition), fluid may be relieved from the pressurized passage to tank 98 via relief valves 88 and common passage 90. Alternatively or additionally, the pressurized fluid may be directed into accumulators 106 via accumulator passages 108, 110, valves 114, and common passage 112. In contrast, when the fluid pressure becomes too low, fluid from charge circuit 64 may be allowed into circuit 58 via common passage 90 and makeup valves 86.

As described above, desired operation of all the actuators within a single circuit may drive displacement control of pumps 66. When motion of multiple actuators within a single circuit is simultaneously desired, however, directional displacement control of the associated pump 66 may be driven based solely on the desired motion of only a single actuator (although the displacement magnitude of pump 66 may still be based on flow requirements of all the actuators). At this time, in order to cause the single actuator to move in a desired direction at a desired speed and/or with a desired torque, the displacement of the actuator and/or fluid flow into the actuator may be may be selectively regulated.

As also described above, hydraulic cylinders may discharge more fluid from first chamber 52 during retracting operations than is consumed within second chamber 54, and consume more fluid that is discharged from second chamber 54 during an extending operation. During these operations, accumulator valves 114 may be selectively opened to allow the excess fluid to enter and fill accumulators 106 (when the excess fluid has a sufficiently high pressure, for example during an overrunning condition) or to exit and replenish circuit 58, thereby providing a neutral balance of fluid entering and exiting pump 66.

It is contemplated that, in some embodiments, it may be desirable to partially or fully isolate the suction or low-pressure side of pump 66 from its associated hydraulic cylinder during the overrunning condition, such that a greater amount of fluid discharged from the hydraulic cylinder may be directed into accumulators 106 and stored for later use rather than returned to pump 66. During this time, pump 66 may receive makeup fluid from charge circuit 64. An isolation valve (not shown) similar to valve 76 may be disposed within lower pump and/or upper actuator passages 70, 72, between resolver 92 and the junction of valve 76 with upper pump passage 68, and used to isolate the low-pressure side of pump 66.

Regeneration of fluid may be possible during retracting operations of the hydraulic cylinder, when the pressure of fluid exiting first chamber 52 is elevated (e.g., during motoring retracting operations). Specifically, during the retracting operation described above, both of makeup valves 86 may be simultaneously moved toward their flow-passing positions. In this configuration, makeup valves 86 may allow some of the fluid exiting first chamber 52 to bypass pump 66 and flow directly into second chamber 54. This operation may help to reduce a load on pump 66, while still satisfying operator demands, thereby increasing an efficiency of machine 10. In some embodiments, makeup valves 86 may be held partially closed during regeneration to facilitate some energy dissipation that improves controllability.

Second and third circuits 60, 62 may selectively provide fluid to hydraulic cylinder 34 and/or to each other by way of second and third combining valves 87, 89. For example, based on an operator command to curl work tool 14, controller 124 may generate a control signal that causes pump 66 of second circuit 60 and/or pump 66 of third circuit 62 (depending on demands for flow from each actuator and capacity of the different pumps) to increase their displacement and discharge fluid into upper or lower pump passage(s) 68, 70 at a greater rate. This fluid may then be passed from upper pump passage(s) 68 through the appropriate one or more of combining valves 87, 89 to switching valve 91, wherein the direction of hydraulic cylinder 34 may be controlled via movement of switching valve 91 to the first or third positions. Alternatively, switching valve 91 may be held in its second position and substantially isolate hydraulic cylinder 34 from second and third circuits 62, 64 while both of combining valves 87, 89 are held open, such that fluid may be passed from one of second and third circuits 60, 62 (i.e., from the higher-pressure one) to the other, thereby increasing a flow rate of fluid made available to the lower-pressure circuit.

In the disclosed embodiments of hydraulic system 56, flows provided by pumps 66 may be substantially unrestricted such that significant energy is not unnecessarily wasted in the actuation process. Thus, embodiments of the disclosure may provide improved energy usage and conservation. In addition, the closed-loop operation of hydraulic system 56 may, in some applications, allow for a reduction or even complete elimination of metering valves for controlling fluid flow associated with the linear and rotary actuators. This reduction may result in a less complicated and/or less expensive system.

The disclosed hydraulic system may also provide for fluid power storage, reuse, and flow combining between multiple, closed-loop, circuits. That is, the configuration of hydraulic system 56 may allow for excess fluid power from one closed-loop circuit to be accumulated and later used within another closed-loop circuit or to be directly routed between circuits for immediate use.

It will be apparent to those skilled in the art that various modifications and variations can be made to the disclosed hydraulic system. Other embodiments will be apparent to those skilled in the art from consideration of the specification and practice of the disclosed hydraulic system. For example, although valves 114, 76, 78, 80, 82, and 84 are shown and described in some circuits as being two-position, on/off type valves, it is contemplated that these valves could alternatively be proportional in nature to facilitate additional functionality. For example, if accumulator valve 114 were proportional, accumulators 106 could be simultaneously charged by each of second and third circuits 60, 62, even if the circuits have different pressures. In this situation, accumulator charging would be done at the lowest pressure and some throttling might be required. In addition, although pumps 66 are described as being over-center type pumps, it is contemplated that pumps 66 may alternatively be unidirectional pumps, if desired. In this situation, energy transferred through the pump (i.e., from any rotary and/or linear actuators) will be limited to a single direction. Further, although first circuit 58 is shown as including swing motor 43 and hydraulic cylinder 32, it is contemplated that first circuit 58 could alternatively include left travel motor 42L and hydraulic cylinder 34, if desired (i.e., the relative positions of swing motor 43 and left travel motor 42L would be swapped, and the relative positions of hydraulic cylinders 32 and 34 would be swapped). It is intended that the specification and examples be considered as exemplary only, with a true scope being indicated by the following claims and their equivalents.

What is claimed is:

1. A hydraulic system, comprising:
a plurality of closed-loop circuits fluidly connecting a plurality of pumps to a plurality of actuators;
at least one control valve configured to selectively fluidly connect a first of the plurality of closed-loop circuits to a second of the plurality of closed loop circuits; and
an accumulator configured to receive pressured fluid from and discharge pressurized fluid to at least the first of the plurality of closed-loop circuits.

2. The hydraulic system of claim 1, wherein a number of the plurality of actuators is greater than a number of the plurality of pumps.

3. The hydraulic system of claim 1, wherein:
the first of the plurality of closed-loop circuits includes a first rotary actuator and a first linear actuator;
the second of the plurality of closed-loop circuits includes a second linear actuator; and
a third of the plurality of closed-loop circuits includes a second rotary actuator and third rotary actuator.

4. The hydraulic system of claim 3, wherein the accumulator is configured receive pressurized fluid from and discharge pressurized fluid to only the first and third of the plurality of closed-loop circuits.

5. The hydraulic system of claim 4, further including at least one accumulator control valve disposed between each of the first and second of the plurality of closed-loop circuits and the accumulator.

6. The hydraulic system of claim 3, further including a third linear actuator selectively connectable in closed-loop manner to first or third of the plurality of closed-loop circuits.

7. The hydraulic system of claim 6, wherein:
the at least one control valve is a first control valve;
the hydraulic system further includes:
second control valve disposed between the first of the plurality of closed-loop circuits and the third linear actuator; and
a third control valve disposed between the third of the plurality of closed-loop circuits and the third linear actuator; and
the second and third control valves may be utilized together to selectively fluidly connect the second of the plurality of closed-loop circuits to the third of the plurality of closed loop circuits.

8. The hydraulic system of claim 6, further including a charge circuit configured to receive excess fluid from and provide makeup fluid to the first, second and third of the plurality of closed-loop circuits.

9. The hydraulic system of claim 8, wherein each of the first and third circuits includes:
at least one relief valve associated with the charge circuit; and
a resolver configured to selectively connect a higher of multiple actuator pressures with the at least one makeup valve.

10. The hydraulic system of claim 6, wherein:
the first rotary actuator is a swing motor;
the first linear actuator is a stick cylinder;
the second linear actuator is a boom cylinder;
the second rotary actuator is a travel motor;
the third rotary actuator is a travel motor; and
the third linear actuator is a boom cylinder.

11. The hydraulic system of claim 6, further including at least one switching valve associated with each of the first and second linear actuators and configured to selectively switch a flow direction through the first and second linear actuators.

12. The hydraulic system of claim 11, wherein each of the first, second, and third rotary actuators are over-center, variable-displacement actuators.

13. The hydraulic system of claim 12, wherein each of the plurality of pumps is an over-center, variable-displacement pump.

14. The hydraulic system of claim 12, further including at least one isolation valve associated with each of the first, second, and third rotary actuators and configured to selectively isolate the first, second, and third rotary actuators from an associated one of the plurality of pumps.

15. A hydraulic system, comprising:
a first closed-loop circuit fluidly connecting a first pump with a first rotary actuator and a first linear actuator in parallel;
a second closed-loop circuit fluidly connecting a second pump with a second linear actuator;
a third closed-loop circuit fluidly connecting a third pump with a second rotary actuator and a third rotary actuator;
a third linear actuator selectively connectable to either the second or third closed-loop circuits;
a first control valve configured to selectively fluidly connect the first closed-loop circuit to the second closed loop circuit;
a second control valve configured to selectively fluidly connect the second closed-loop circuit to the third linear actuator;
a third control valve configured to selectively fluidly connect the third closed-loop circuit to the third linear actuator; and
an accumulator configured to receive pressured fluid from and discharge pressurized fluid to only the first and third closed-loop circuits,
wherein the second and third control valves may be utilized together to selectively connect the second and third closed-loop circuits.

16. A method of operating a hydraulic system, comprising:
pressurizing fluid with a plurality of pumps;
directing fluid pressurized by the plurality of pumps to a plurality of actuators and returning fluid from the plurality of actuators to the plurality of pumps via a plurality of closed-loop circuits;
selectively directing fluid from at least a first of the plurality of closed-loop circuits to combine with fluid within a second of the plurality of closed-loop circuits;
selectively accumulating within a common accumulator fluid from at least the first of the plurality of closed-loop circuits; and
selectively discharging fluid from the common accumulator to at least the first of the plurality of closed-loop circuits.

17. The method of claim 16, wherein a number of the plurality of actuators is greater than a number of the plurality of pumps.

18. The method of claim 16, wherein:
the plurality of actuators includes:
a first rotary actuator and a first linear actuator associated with the first of the plurality of closed-loop circuits;
a second linear actuator associated with the second of the plurality of closed-loop circuits;
a second rotary actuator and a third rotary actuator associated with a third of the plurality of closed-loop circuits; and
a third linear actuator selectively connectable to the second and third of the plurality of closed-loop circuits;
selectively accumulating includes selectively accumulating within the common accumulator fluid from only the first and third of the plurality of closed-loop circuits; and
selectively discharging includes selectively discharging fluid from the common accumulator to only the first third of the closed-loop circuits.

19. The method of claim 18, wherein:
the third linear actuator is selectively connectable to the second and third of the plurality of closed-loop circuits via control valves; and
the method further includes selectively directing fluid from the second of the plurality of closed-loop circuits to combine with fluid within the third of the plurality of closed-loop circuits via the control valves.

20. The method of claim 19, further including directing fluid from the plurality of closed-loop circuits to a charge circuit and from the charge circuit to the plurality of closed-loop circuits.
